(19) United States
(12) Patent Application Publication
(10) Pub. No.: US 2010/0176773 A1
(43) Pub. Date: Jul. 15, 2010

(54) CIRCUIT AND METHOD FOR CONTROLLING THE POINT OF MAXIMUM POWER FOR SOLAR ENERGY SOURCE AND SOLAR GENERATOR INCORPORATING SAID CIRCUIT

(76) Inventor: Antoine Capel, Tarragona (ES)

Correspondence Address: DENNIS G. LAPOINTE;LAPOINTE LAW GROUP, PL, PO BOX 1294, TARPON SPRINGS, FL, 34688-1294, US

(21) Appl. No.: 12/294,955

(22) PCT Filed: Mar. 30, 2007
(86) PCT No.: PCT/ES2007/000184

§ 371 Date: Sep. 30, 2008

(30) Foreign Application Priority Data
Mar. 31, 2006 (ES) P200600843

(51) Int. Cl. G05F 1/67

(52) U.S. Cl. 323/266

(57) ABSTRACT

The invention is designed for continuous, rapid and effective monitoring of a solar or equivalent source in order successfully to arrange for it to operate at its point of maximum power (PMP) without interrupting the supply of electricity to users, with a conventional power-regulating structure of series or parallel type, governed by an independent module capable of calculating the voltage and current coordinates of said PMP (VPMP, IPMP) by applying an iterative algorithm and/or graphic methods. This module ideally requires only one measurement point, relating to the electrical characteristic, with the ambient conditions of said source, and as a result it delivers a reference signal, a continuous, stable voltage constantly representative of the evolution of the PMP, for the power regulator. In the event of the use of a power-regulating structure of S3R or ASR type, information about the PMP is immediate and requires no intermediate measurement point.

### RELATED APPLICATION

This application is a 35 USC 371 national stage application of international application PCT/ES2007/000184 filed Mar. 30, 2007, which claims priority from Spain application P200600843 filed Mar. 31, 2006.

### OBJECT OF THE INVENTION

The present invention has its main field of application in the industry destined to the design of electronic devices and, more specifically, within the sector of photovoltaic solar energy power systems.

One object of the invention is to permit the energy source to work at its Point of Maximum Power (PMP), whenever this condition is required by the users, in a permanent manner without causing any discontinuity in the voltage it supplies.

Likewise, an object of the invention is to provide a power control circuit for a solar generator with a high performance which continuously determines said Point of Maximum Power (PMP) quickly.

### BACKGROUND OF THE INVENTION

Solar generators, such as those that comprise photovoltaic panels, are currently widely used both in space power systems (stations, satellites, probes and other space vehicles) and land power systems (buildings with renewable energy systems, etc.), due to their independence from any electrical distribution network, with the advantageous capacity of supplying energy in an autonomous way both to fixed and mobile equipment.

When speaking about solar energy, one can distinguish between thermosolar which, by means of solar collectors, uses the sun's radiation to produce hot water for home or commercial use by greenhouse effect, aside from the photovoltaic panels used to generate electricity for photovoltaic effect, amongst other classes of systems whereto solar radiation is also applied: thermoelectric systems to produce electricity with a conventional thermodynamic cycle from fluid heated by the sun, passive systems which use the sun's heat without the necessity of intermediary mechanisms and hybrid systems which combine solar energy with the combustion of biomass or fossil fuels.

These energy sources feature a power whose characteristic curve reaches a maximum for certain single voltage value, called in the state of the art Point of Maximum Power (PMP). Problems arise when the designer of the power system tries to get the solar panel to work at the PMP for obvious reasons of reduction of mass and cost. Most of the power systems of this type known up until now achieve that objective by implementing a tracking algorithm, called MPPT (Maximum Power Point Tracking), in the control loop of the unit in charge of managing this energy source or power conditioning unit.

The MPPT power regulation method permits the photovoltaic panels, modules or collectors to supply all of the power available varying electronically its operating point. The benefit of carrying out the MPPT is evident against the conventional power controllers, where the panels connect directly to the user charging network (for example, to charge a battery), forcing them then to operate at the voltage level of the battery itself, which frequently does not correspond to the ideal voltage for the photovoltaic panels to give the maximum power. Additionally, the MPPT tracking can be used in conjunction with the typical mechanical control, wherein the panels move automatically to optimize their aim towards the sun.

But in order for a solar panel to work at its PMP, if this condition is accepted by the users, in permanent manner, nowadays the applicant only knows a technique divulged by the inventor of that present and which is disclosed in French Patent FR2844890. The power conditioning unit contemplated by FR2844890 generates a control signal corresponding to the difference between the instantaneous voltage and the PMP voltage value which serves as reference to said conditioning unit. The drawback is that it is not possible without affecting the continuity of the voltage supplied to the user. The reason lies in that the calculation of said reference voltage which is made, according to the process explained in FR2844890, previously requires determining a solution to the characteristic power equation, represented by the current-voltage curve, in order to obtain the new PMP, i.e. the voltage values and currents present corresponding to the maximum power. This is a drawback, because the unit or power circuit and, therefore, the solar generator which incorporates it require the interruption of the supply voltage, as it uses in the PMP controlling an algorithm which needs the measurements of exactly four points of the electric characteristic of the solar panel, with the consequent loss of performance and velocity of the regulation of the power of the generator.

### DESCRIPTION OF THE INVENTION

The present invention is intended for its application in the control and conditioning of power, in general, for solar energy sources whose electric characteristic has a single Point of Maximum Power (PMP) and, in particular, relates to a method and to the circuit where is implemented that which resolves, amongst others, the previously stated problem, in each and every one of the aforementioned different aspects, constituting an alternative for the calculation of the improved PMP compared to the prior systems.

Specifically, the method and circuit of the invention present important advantages in comparison to the solution set out in FR2844890, based on a fundamental aspect in order to determine said PMP and which is the number of points of the real electric characteristic of the source, which is preferably a photovoltaic panel or a grouping of solar panels, necessary for the calculations. Unlike what is required in FR2844890, here it is not necessary to have a fixed number of points of the electric characteristic and equal to the four measurement points, but rather in the present invention fewer are needed, in the best of cases a single measurement point situated between the “old” PMP and the “new” PMP, in order to calculate the new PMP, i.e. the updated voltage coordinates and instantaneous current which correspond to the maximum of the power function.

This results in a faster method, as well as the production of a power control circuit and, therefore, of a solar generator connected thereto, with better performance. From the viewpoint of the user, the circuit performs like a discrete-time servosystem, acting as a classic power regulator which finds its new PMP at the end of only two samples, always going to the meeting of the current PMP voltage without instabilities, in the direction of the new PMP without oscillations.

One aspect of the invention relates then to a maximum method for controlling the power function P=vi, where the variable v is the instantaneous voltage and the variable i is the current of a generator or solar source, which is connected to a user loading network by means of a power conditioning unit. Therefore, the so-called Point of Maximum Power (PMP) is defined by voltage and current coordinates (Vₚₘₚ, Iₚₘₚ) which the method is responsible for determining from a single measurement point of the electric characteristic of said source. This method delivers to the power conditioning unit, in continuous manner or in sample mode, a reference signal in correspondence to the current value of the voltage Vₚₘₚ, i.e. the reference voltage to the input of the conditioning power unit is rigorously proportional or equal to the instantaneous voltage value at the Point of Maximum Power (PMP). This reference voltage is applied by the power conditioning unit to regulate the output voltage of the solar source, without needing to interrupt the supply of voltage to the aforementioned user loading network, as conventional power regulators usually do.

The solar generator comprises preferably a photovoltaic panel or a grouping of such panels or is an equivalent energy source, whose definition of the electric voltage characteristic depends on the function of the voltage v(i) expressed, linking the coordinates of the working point in certain operating conditions, such as temperature, aging and lighting level in the solar panel, according to the following relationship developed by Tada and Carter during the 1980s:

$$v = \frac{nAkT}{q} Log ( 1 + \frac{{mi}_{sc} - i}{{mi}_{R}} ) \qquad ( 2.1 )$$

In expression (2.1), n is defined as the number of photovoltaic cells in series in each one of the m columns of cells of the panel. The parameter A is the so-called form factor of the characteristic and kT/q is a coefficient which depends on the temperature and on the material of the cell. Also intervening in this equation (2.1) are the respective values of the short circuit current i_{sc} and of the dark current i_{R} of a photovoltaic cell for given working conditions.

The current and power coordinates of the working point at a moment (t) are given respectively by the expressions:

$$i ( t ) = m ( {i}_{SC} ( t ) - {i}_{R} ( exp ( \frac{qv ( t )}{nAkT} ) - 1 ) )$$

$$P ( t ) = v ( t ) i ( t )$$

From the foregoing it is derived that the coordinates of the Point of Maximum Power (PMP) can be calculated by solving the equation:

$$\frac{d P}{d v} = \frac{nAkT}{q} ( Log ( \frac{{mi}_{SC} - {i}_{PMP}}{{mi}_{R}} ) - \frac{{i}_{PMP}}{{mi}_{R} ( 1 + \frac{{i}_{SC} - {i}_{PMP}}{{mi}_{R}} )} ) = 0$$

Taking into account that the value of the dark current i_{R} is very small compared to the short circuit current i_{sc} and is also much less than the current imp, the equation (2.1) particularized in the Point of Maximum Power (PMP) can be written according to the following formula:

$${v}_{PMP} = \frac{nAkT}{q} Log ( 1 + \frac{{mi}_{SC} - {i}_{PMP}}{{mi}_{R}} ) ≅ na Log ( \frac{{mi}_{SC} - {i}_{PMP}}{{mi}_{R}} ) \qquad ( 2.2 )$$

Thus, in order to establish the voltage vₚₘₚ, apart from determining the currents i_{R} and i_{sc} and the constant “a” which depends on the working conditions, the temperature and the material of the photovoltaic cells, the method proposed calculates the current iₚₘₚ.

Since the coordinates of the Point of Maximum Power (PMP) analytically correspond to the maximum of the power function P=vi, this extreme operative condition implies that at the Point of Maximum Power (PMP) the following expression is true:

dP=vₚₘₚdi+iₚₘₚdv=0 (2.3)

or what is the same:

$$\frac{d v}{d i} = - \frac{{v}_{PMP}}{{i}_{PMP}} \qquad ( 2.4 )$$

In turn, deriving the electric voltage characteristic (2.1) one obtains:

$$\frac{d v}{d i} = - \frac{n}{m} \frac{AkT}{{qi}_{R}} \frac{1}{1 + \frac{m {i}_{SC} - {i}_{PMP}}{m {i}_{R}}} = f ( {i}_{PMP} ) \qquad ( 2.5 )$$

Combining (2.4) and (2.5), the voltage Vₚₘₚ is written as follows:

$${v}_{PMP} = \frac{n}{m} \frac{AkT}{{qi}_{R}} \frac{{i}_{PMP}}{1 + \frac{m {i}_{SC} - {i}_{PMP}}{m {i}_{R}}} = n \frac{AkT}{q} Log ( 1 + \frac{m {i}_{SC} - {i}_{PMP}}{m {i}_{R}} ) \qquad ( 2.6 )$$

or in equivalent manner:

$$\frac{{i}_{PMP}}{m {i}_{R} ( 1 + \frac{m {i}_{SC} - {i}_{PMP}}{m {i}_{R}} )} - Log ( 1 + \frac{m {i}_{SC} - {i}_{PMP}}{m {i}_{R}} ) = 0 \qquad ( 2.7 )$$

In order to solve the equation (2.7), two methods can be applied: one numerical and another graphic.

The numerical method is based on the Newton-Raphson iterative algorithm. After j+1 iterations in the variable I, the solution to the previous equation (2.7) can be expressed in the following manner:

$${i}^{( j + 1 )} = {i}^{( j )} - \frac{f ( {i}^{( j )} )}{\frac{d f ( {i}^{( j )} )}{d i}} \qquad ( 2.8 )$$

being:

$$f ( {i}^{( j )} ) = \frac{{i}^{( j )}}{{mi}_{R} ( 1 + \frac{{mi}_{SC} - {i}^{( j )}}{{mi}_{R}} )} - Log ( 1 + \frac{{mi}_{SC} - {i}^{( j )}}{{mi}_{R}} ) \qquad ( 2.9 )$$

The graphic method consists of finding the intersection of two curves or functions f1 and f2, which follow the analytic expressions:

$$\begin{matrix}{f}_{1} ( i ) = tg θ = \frac{v}{i} = \frac{nA kT}{q i} Log ( 1 + \frac{{mi}_{SC} - i}{{mi}_{R}} ) \\ and & ( 2.10 ) \\ {f}_{2} ( i ) = \vert \frac{d v}{d i} \vert = \frac{n}{m} \frac{AkT}{{qi}_{R}} \frac{1}{1 + \frac{{mi}_{SC} - i}{{mi}_{R}}} & ( 2.11 )\end{matrix}$$

These two functions f1 and f2 have a single intersection point which corresponds precisely to the coordinates looked for (Vₚₘₚ, Iₚₘₚ) in the current or real operating conditions.

With respect to the calculation of the dark current i_{R} of the photovoltaic cell, the experience shows that its value suffers little variation since it is linked to the solid-state physics of the cell and, therefore, can easily be produced from the information of the manufacturer of the solar panel (or equivalent source) given for normal working conditions (1 atmosphere and 27° C.). Specifically, the values in such normal working conditions being known for the voltage and current in the PMP (vₚₘₚ, iₚₘₚ), along with the short circuit current i_{sc} and the voltage of the open circuit voc, it can take as initial value of i_{R}:

$${i}_{R} = \frac{{i}_{SC}}{exp ( \frac{AkT}{q} {v}_{OC} ) - 1} \qquad ( 2.12 )$$

being:

$$A = \frac{q}{kT} \frac{2 {v}_{PMP} - {v}_{OC}}{\frac{{i}_{PMP}}{{i}_{SC} - {i}_{PMP}} + Log \frac{{i}_{SC} - {i}_{PMP}}{{i}_{SC}}} \qquad ( 2.13 )$$

With a regular functioning, the data gathered from measurements are going to permit the microprocessor to periodically (for example, every 100 changes of PMP) know the real dark current without this having effect on the voltage imposed on the solar panel. With regard to the other parameters involved in the electric characteristic of the source, the production of the short circuit current i_{sc} and the constant “a” in the current working conditions imply finding the solution to a system of equations with two unknown quantities, which can be solved by means of a graphic method and an iterative calculation algorithm, such as the previously mentioned Newton-Raphson method, from the initial value of the dark current i_{R}.

In order to solve the system of equations with two unknown quantities, the coordinates of two points of the electric characteristic of the solar panel are used.

The first point M1 (v1,i1) is the present operation point. It is characterized by its voltage v1 which is always at the value of the preceding PMP, the “old” PMP, but with a current i1 that has changed, as it is not the new PMP or the old PMP. The measurement of the difference between the current values allows us to find out where the new PMP is found at the same time that it indicates an estimate of its distance. If the difference is positive, the voltage of the new PMP is also larger than that of the old PMP; while if it is negative, it will have a lower voltage.

Thus knowing the direction of the new PMP, the method for controlling changes the working point of the solar panel imposing a positive step (if the difference i1−iₚₘₚ “old” is positive) or negative (if the difference i1−iₚₘₚ “old” is negative) to the reference of the power regulator. The amplitude of this step is proportional, with a constant kᵥ selected by the user, to the amplitude of the difference of said current values. The second point M2(v2,i2) is necessary to find the coordinates of the new PMP. The third point M3(v3,i3) is calculated as a result by the processor, its coordinates being those of the midpoint of the segment M1M2. The algorithm uses the property that this segment is parallel to the tangent at the point of the characteristic which has the same voltage as the point M3. It can be written:

$${v}_{3} = \frac{{v}_{1} + {v}_{2}}{2} and {i}_{3} = \frac{{i}_{1} + {i}_{2}}{2} \qquad ( 2.14 )$$

The gradient p to the characteristic curve corresponds to:

$$\frac{d v}{d i} = - \frac{n}{m} \frac{AkT}{{qi}_{R}} \frac{1}{1 + \frac{{mi}_{SC} - {i}_{3}}{{mi}_{R}}} ≅ - na \frac{1}{{mi}_{SC} - {i}_{3}} = p$$

Since M3 is on the characteristic, its voltage v3 is:

$${v}_{3} = \frac{nA kT}{q} Log ( 1 + \frac{{mi}_{SC} - {i}_{3}}{{mi}_{R}} ) ≅ na Log ( \frac{{i}_{SC} - {i}_{3}}{{i}_{R}} ) \qquad ( 2.16 )$$

We can eliminate the constant a by doing:

$$na = - p ( {mi}_{SC} - {i}_{3} ) = \frac{{v}_{3}}{Log ( \frac{{i}_{SC} - {i}_{3}}{{i}_{R}} )} \qquad ( 2.17 )$$

The knowledge of the short circuit current (i_{sc}) is found by solving this equation with the Newton-Raphson iterative algorithm. After j+1 iterations we obtain:

$${i}_{SC}^{( j + 1 )} = {i}_{SC}^{j} - \frac{f ( {i}_{SC}^{( j )}}{\frac{d f ( {i}_{SC}^{j} )}{d {i}_{SC}}} \qquad ( 2.18 )$$

knowing that:

$$f ( {i}_{SC}^{( j )} ) = \frac{{v}_{3}}{np ( \frac{{mi}_{SC}^{( j )} - i )}{{mi}_{R}}} = - Log ( \frac{{mi}_{SC}^{( j )} - i )}{{mi}_{R}} \qquad ( 2.19 )$$

Finally, the last parameter is given by:

$$\frac{nA kT}{q} \approx na = - p ( {mi}_{SC} - {i}_{3} ) \qquad ( 2.20 )$$

Another aspect of the invention is a control circuit of the Point of Maximum Power for solar energy sources, whose electric characteristic has a single PMP for working conditions wherein the solar source operates in accordance with each moment, which comprises:
A power conditioning unit connected between the solar source and a user loading network, through a power cell, in order to regulate the output voltage of said source and supplying an optimal voltage to the user loading network, with a maximum performance.
And a fast calculation module of the coordinates of the Point of Maximum Power (PMP). The calculation module proposed herein is connected to the power cell and comprises at least one programmable electronic device, for example a microprocessor (PIC) which applies the method previously described to establish Vₚₘₚ, without interrupting the voltage supply to the user loading network.

Additionally, for said function, the calculation module provides storage means, a memory integrated or not in the programmable electronic device, capable of saving the necessary data in the establishment of the voltage Vₚₘₚ.

Said calculation module, which can be integrated or not in the power conditioning unit, incorporates digital analogue converters to receive the measurement points of the electric characteristic and digital analogue converters to deliver the reference voltage to the power cell of said power conditioning unit, which constitute an interface with the solar source.

The programmable electronic device, which can be a general purpose microprocessor, a digital signal microprocessor (DSP), an application specific integrated circuit (ASCI), a programmable card (FPGA) or any other combination of the foregoing, is in charge of establishing the values continuously updating from the working point of the solar panel or from the equivalent energy source, accessing the real electric characteristics of the source and obtaining therefrom, with one, two or at most three measurement points, the voltage of the PMP. This voltage is that which is used as a reference of the power conditioning unit, which conventionally can have a converted structure of series type or parallel type, for example with topologies of known power regulators such as S3R or ASR.

The data of the manufacturer and relative to the configuration of the solar panel, together with the measurements of its electric characteristic, are saved in a memory or database, with the aim that the programmable electronic device can access them and execute the specific calculations and iterative algorithms in order to solve the non-linear equations implicated in the control method set out.

Optionally, the circuit comprises means of receiving the instantaneous measurements and a current pick-up adapted to measure the value of the current in real time.

When the difference between the value of the current in real time and that of the current iₚₘₚ at the Point of Maximum Power (PMP) surpasses a pre-determined limit, the programmable electronic device is thus configured to adjust the new working coordinates returning to execute the PMP controlling method, considerably fast since it only requires a single measurement point always in direction of the final value of the new PMP, in the characteristic curve of the source.

A final aspect of the invention relates to a solar generator, comprising a source so that the electric characteristic curve of voltage depending on the current has a single PMP corresponding to the maximum of the power function P=vi, which incorporates the control circuit of the Point of Maximum Power for solar energy sources as has been previously defined.

### DESCRIPTION OF THE DRAWINGS

In order to complement the description being carried out and with the purpose of helping towards a better understanding of the characteristics of the invention, in accordance with a preferred example of embodiment thereof, a set of drawings is attached as an integral part of said description, wherein the following, in an illustrative and non-limitative character, has been represented.

FIG. 1 shows a graphic representation of the power function P=vi, the function f1=v/l and the function f2=dv/di of a solar energy source which presents a Point of Maximum Power (PMP), whose voltage and current coordinates (Vₚₘₚ, Iₘₚ) are established in accordance with the object of the invention.

FIG. 2 shows a diagram of blocks of the circuit of the invention as possible embodiments in power conditioning unit of topology series.

FIG. 3 shows a diagram of blocks of the circuit of the invention as another possible embodiment in power conditioning unit of parallel topology.

FIG. 4 shows a graphic representation of the power function P=vi and a curve of current I depending on the voltage v which defines the electric characteristic of the solar source.

FIG. 5 shows an illustration of the graphic search method of the PMP in the electric current-voltage characteristic of the energy source for different working points, gathering three measurement points.

FIG. 6 shows an illustration of the graphic search method of the PMP in the electric current-voltage characteristic of the energy source for different working points, gathering two measurement points.

FIG. 7 shows a diagram of blocks of a parallel regulator structure type S3R for the power conditioning unit, according to an example of embodiment.

FIG. 8 shows a diagram of blocks of a parallel regulator structure type S4R for the power conditioning unit, according to another alternate example of embodiment.

FIG. 9 shows a connection circuit of a plurality of S4R type units for the power conditioning, according to another example of embodiment.

### PREFERRED EMBODIMENT OF THE INVENTION

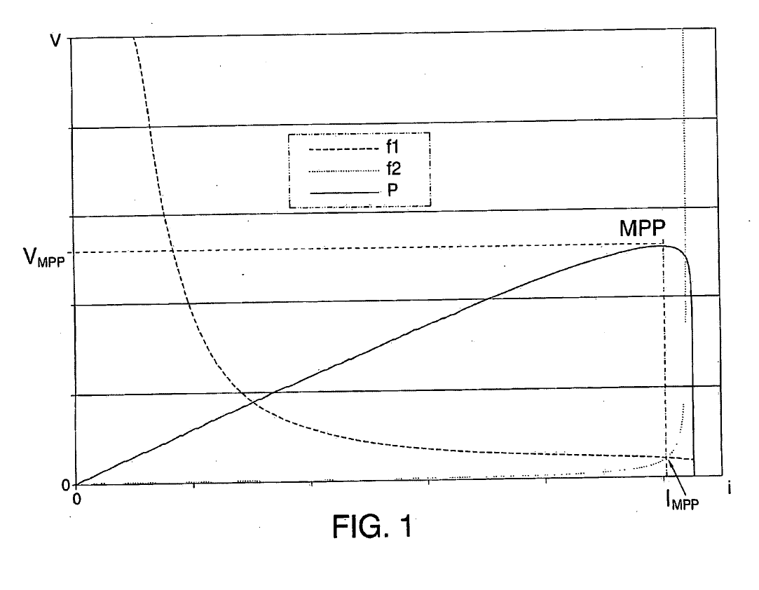

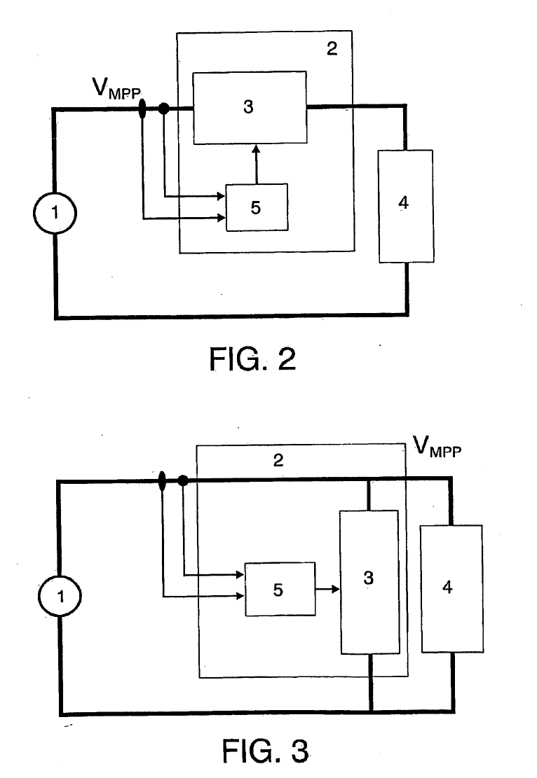

In view of the figures shown, a method for controlling the Point of Maximum Power for solar energy sources can be described as a possible practical option of embodiment of the invention, whose electric voltage characteristic (v) depending on the current (i) has a single Point of Maximum Power (PMP) corresponding to the maximum of the power function (P), P=vi, as is shown in FIG. 1. The source (1) is connected to a user loading network (4), by means of a power conditioning unit (2), as is illustrated in FIGS. 2 and 3, respectively, depending on whether the power regulator is configured with a power cell (3) in series or in parallel.

In said solar source (1) is disposed a plurality of photovoltaic cells distributed in a number of rows (n) and a number of columns (m). A calculation model (5) of the Point of Maximum Power (PMP) connected to the power cell (3) established a reference voltage (Vₚₘₚ), solving the equation:

$${v}_{MPP} = na Log ( \frac{{mi}_{SC} - {i}_{MPP}}{{mi}_{R}} ) \qquad ( 2.21 )$$

In order to determine the voltage (Vₚₘₚ) of the Point of Maximum Power (PMP), the calculation model (5) performs three consecutive operations:

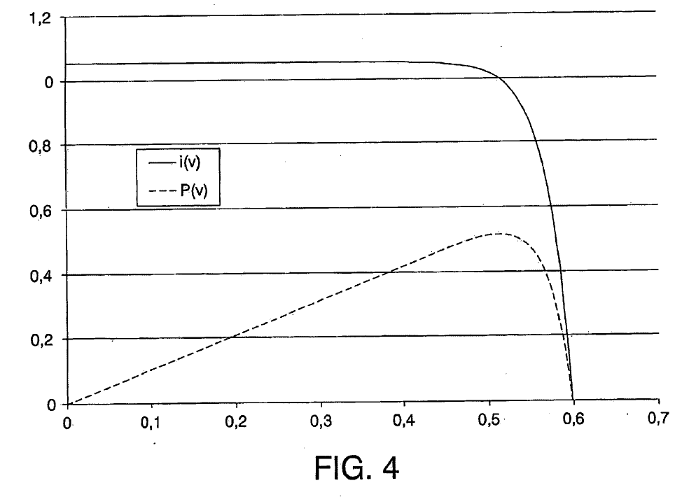

i) identification of the new analytic formula i(v) of the electric characteristic, such as that drawn in FIG. 4, which presents the solar source (1), in accordance with the equations:

$$i ( t ) = m ( {i}_{SC} ( t ) - {i}_{R} ( exp ( \frac{qv ( t )}{nA kT} ) - 1 ) )$$

$$P ( t ) = v ( t ) i ( t )$$

This operation is completed when it has identified or calculated the parameters: form factor of the characteristic (A), short circuit current (i_{sc}) and dark current (I_{R}).

ii) Resolution of the extreme condition which characterizes the existence of a maximum in the power curve of the solar source (1), i.e., the condition given by the expression:

$$\frac{d P}{d v} = \frac{nA kT}{q} ( Log ( \frac{{mi}_{SC} - {i}_{PMP}}{{mi}_{R}} ) - \frac{{i}_{PMP}}{{mi}_{R} ( 1 + \frac{{i}_{SC} - {i}_{PMP}}{{mi}_{R}} )} ) = 0$$

iii) Calculation of the voltage (Vₚₘₚ) for its delivery the power conditioning unit (2) in the form of an analogue reference signal for the regulation of the power, introducing the parameters obtained after the two previous operations in the equation (2.21) which is also written in its exact form as:

$${v}_{PMP} = \frac{nAkT}{q} Log ( 1 + \frac{{mi}_{SC} - {i}_{PMP}}{{mi}_{R}} )$$

Once the voltage (Vₚₘₚ) is calculated, its value is used to deliver a reference signal, equal or proportional to the voltage value (Vₚₘₚ), to the power conditioning unit (2) which controls the solar source (1), regulating the input voltage to the power cell (3) in the event of a converted structure of type series or the voltage applied in the event of a parallel regulator. The power phase does not need any transformation to be inserted in the regulation of the Point of Maximum Power (PMP). The calculation module (5) has at least one microprocessor which processes data coming from a database and the values of the coordinates of the working point of the solar source (1), in order to establish the reference voltage (Vₚₘₚ) which is that of the Point of Maximum Power (PMP). Thus, said source (1) is forced to work permanently at the Point of Maximum Power (PMP), if the user of the network requires.

With the purpose of obtaining the voltage (Vₚₘₚ), previously the microprocessor of the calculation module (5) calculates a series of parameters necessary in the previous equation, namely:

$$\begin{matrix}first parameter ( {i}_{R} ) , & \\ {i}_{R} = \frac{{i}_{SC 0}}{exp ( \frac{{A}_{0} {kT}_{0}}{q} {v}_{OC} ) - 1} & ( 2.22 )\end{matrix}$$

with the data of the manufacturer and used at the beginning.

second parameter (mi_{sc}) which is calculated in iterative form as

$$\begin{matrix}f ( {i}_{SC}^{( j )} ) = \frac{v}{np ( \frac{{mi}_{SC}^{( j )} - i}{{mi}_{R}} )} - Log ( \frac{{mi}_{SC}^{( j )} - i}{{mi}_{R}} ) & ( 2.23 ) \\ third parameter ( na ) & \\ na = - p ( {m i}_{SC} - i ) = \frac{v}{Log ( \frac{{i}_{SC} - i}{{i}_{R}} )} & ( 2.24 )\end{matrix}$$

defining a constant (a) dependent on the material and temperature of the photovoltaic cells of the source (1), the short circuit current (i_{sc}) and the dark current (i_{R}) of said source (1), as well as establishing a value for the current (Iₚₘₚ) at the Point of Maximum Power (PMP).

The calculation of the first parameter (i_{R}) i.e., the dark current is executed by the microprocessor at the beginning, when the solar cells are new; afterwards, the valued of said dark current is re-calculated or updated periodically and stored in the memory of the microprocessor as explained below.

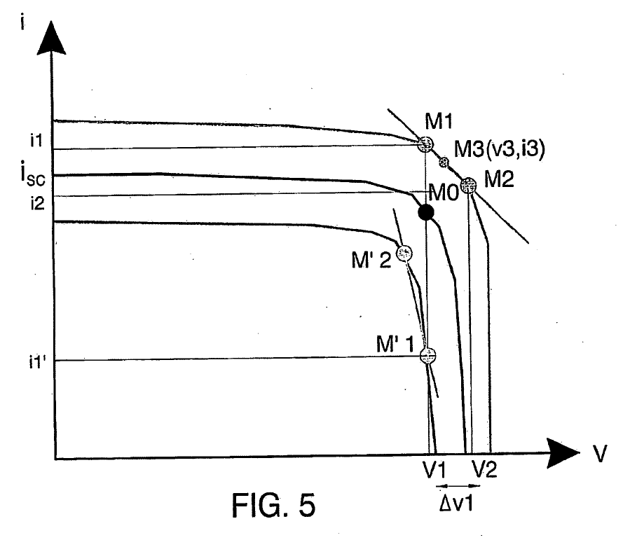

In the instantaneous current-voltage curves of the solar panels represented in FIG. 5, a point (M0) is highlighted corresponding to the “old” Point of Maximum Power (5), having single measurement point (M2, M′2) depending on whether the power of the panel has increased or decreased. This information comes from the sign of the difference between the value of the current of the PMP at the point (M0) and its new value (i₁, l′ᵢ) for the measurement point (M1, M′1), respectively, the voltage of the “old” PMP being v₁=v₀. Graphically, the point M2 is to the right of M1, if the current is greater than that of the “old” PMP, and M′2 is situated to the left of M′1 otherwise. These points will be measured by imposing a step of voltage of an amplitude proportional to the difference in value of the currents. The microprocessor organizes the calculation of the coordinates of the third measurement point (M3, M′3), situated at the midpoint of the segment M1M2 or M′1M′2, wherefrom the coordinates of the “new” Point of Maximum Power (PMP) are determined.

The change of the value of the current cause the microprocessor to receive the instruction to search for the coordinates of the new PMP. It must be borne in mind that the coordinates of the operation point of the solar panel are known at all times by the microprocessor.

Experimentally, it is shown that the value of the dark current (i_{R}) has a minimal variation because said value is linked to the solid-state physics of the photovoltaic cell. Consequently, the microprocessor can take as initial value in its calculations of said dark current (i_{R}), that obtained from certain data of the manufacturer of the solar source (1), which are: the short circuit current in normal pressure and temperature conditions, i.e., at one atmosphere and 27° C., the current and voltage at the Point of Maximum Power (PMP) in said conditions and the open circuit voltage (v_{oc}) of the source (1). With this preliminary data of the manufacturer, the microprocessor calculates in the initialization of the first moment of use of the system the value of the dark current (i_{R}).

If this initial value of the dark current (i_{R}) is introduced, as an input of the microprocessor to perform the first calculation of the Point of Maximum Power (PMP), this value can be periodically updated, for example, every one hundred calculations of the Point of Maximum Power (PMP). Given that each search of the Point of Maximum Power (PMP) only requires in the worst case three measurement points (M₁, M₂, M₃) of the electric characteristic of the solar source (1), it is enough to resolve the simple corresponding mathematical system in order to obtain a new value of the dark current (I_{R}), such as:

$${i}_{R} = \frac{{i}_{SC}}{exp ( \frac{AkT}{q} {v}_{OC} ) - 1} \qquad ( 2.25 )$$

where

$$A = \frac{q}{kT} \frac{2 {v}_{PMP} - {v}_{OC}}{\frac{{i}_{PMP}}{{i}_{SC} - {i}_{PMP}} + Log \frac{{i}_{SC} - {i}_{PMP}}{{i}_{SC}}} \qquad ( 2.26 )$$

In greater detail, the periodic update of the value of the dark current (i_{R}) is made, from the respective coordinates (v₁, i₁), (v₂, i₂), (v₃, i₃) of, in the worst of cases, three measurement points (M₁, M₂, M₃), solving:

$${i}_{1} = m ( {i}_{SC} - {i}_{R} ( exp ( \frac{q}{nAkT} {v}_{1} ) - 1 ) \\ {i}_{2} = m ( {i}_{SC} - {i}_{R} ( exp ( \frac{q}{nAkT} {v}_{2} ) - 1 ) \\ {i}_{3} = m ( {i}_{SC} - {i}_{R} ( exp ( \frac{q}{nAkT} {v}_{3} ) - 1 )$$

The parameter corresponding to the short circuit current (i_{sc}) is eliminated from the previous equations, making:

$${i}_{1} - {i}_{2} = {m i}_{R} ( exp ( \frac{q}{nAkT} {v}_{2} ) - ( exp ( \frac{q}{nAkT} {v}_{1} ) ) \\ {i}_{1} - {i}_{3} = {m i}_{R} ( exp ( \frac{q}{nAkT} {v}_{3} ) - ( exp ( \frac{q}{nAkT} {v}_{1} ) )$$

And solving by means of the Newton-Raphson method or other equivalent method the equation which is posed:

$$( {i}_{1} - {i}_{3} ) exp ( \frac{q}{nAkT} {v}_{1} ) - ( {i}_{1} - {i}_{3} ) exp ( \frac{q}{nAkT} {v}_{2} ) + ( {i}_{1} - {i}_{2} ) exp ( \frac{q}{nAkT} {v}_{3} ) = 0$$

produces the updated values of the dark currents (i_{R}) and of short circuit (i_{sc}), respectively:

$${i}_{R} = \frac{{i}_{1} - {i}_{2}}{exp ( \frac{q}{nAkT} {v}_{2} ) - exp ( \frac{q}{nAkT} {v}_{1} )}$$

$${i}_{SC} = \frac{{i}_{1}}{m} - {i}_{R} ( exp ( \frac{q}{nAkT} {v}_{1} ) - 1 )$$

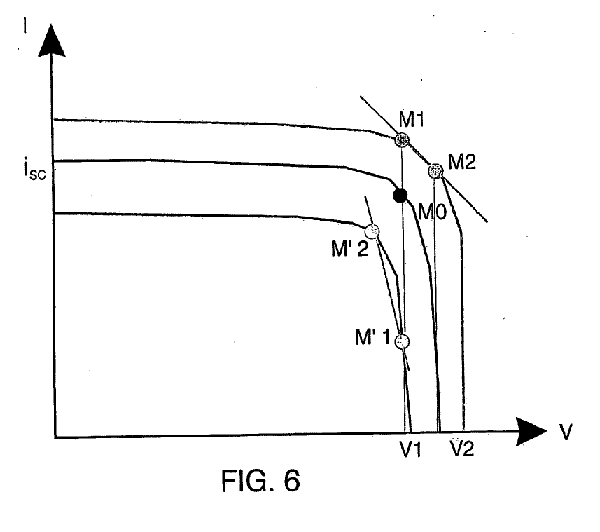

The production of the other two parameters (mi_{sc},na) basically consists of solving a system of equations with two unknown quantities, which is achieved by processing in the calculation module (5) the data available from two working points (M₁, M₂) of the electric characteristic, as is shown in FIG. 6, where the first point (M₁) is defined by coordinates (v1, i1). The voltage (v₁) of said first point (M₁) corresponds to the “old” or already known value of at the Point of Maximum Power (PMP), i.e., at the “old” point (M₀), but the current (i₁) is different from that corresponding to the Point of Maximum Power (PMP) because it varies as the conditions of the solar lighting change. Assuming that this first value of the current (i₁) of the first point (M₁) is greater than the value of the current (Iₚₘₚ) at the Point of Maximum Power (PMP), it can be written:

$${i}_{1} = m ( {i}_{SC} - {i}_{R} ( exp ( \frac{q}{nAkT} {v}_{1} ) - 1 ) \\ y {v}_{1} = \frac{nAkT}{q} Log ( 1 + \frac{{mi}_{SC} - {i}_{1}}{{mi}_{R}} ) ≅ na Log ( 1 + \frac{{mi}_{SC} - {i}_{1}}{{mi}_{R}} ) \qquad ( 2.27 )$$

In FIG. 6, a starting point (Mₒ) of the electric characteristic is observed, whose coordinates are those of the “old PMP” and which moves to M1 (v1,i1) with the change of PMP. Consequently, the “future” value of the Point of maximum Power (PMP), which determines a new point (M₂) of the characteristic, is situated to the right of the first point (M₁). Otherwise, supposing that the first value of the current (i₁) is of smaller amplitude than that of the “old” Point of Maximum Power (PMP), the “future” value is situated to the left of the first point (M₀) and determines another point (M′₁) of the electric characteristic. Adding a small positive increase (Δv₁) to the first voltage (v1) which is serving as a reference to the power conditioning unit (2), the second point (M₂) is measured in the electric characteristic, whose coordinates (v₂, i₂) are drawn in FIG. 6). This second point (M₂) corresponds to in intermediate point directly in the vicinity of the Point of Maximum Power (PMP) or is already the same, obtaining according to the sign of the variation between the previous value of the current stored in the memory and the value measured of the current, which when it is negative can correspond to another second point (M′₂).

A second point (M₂) in the electric characteristic measured, a second equation can be established together with (2.27) to calculate the two parameters (mi_{sc},na), or what is the same, the unknown values of the form factor of the characteristic (A) and the short circuit current (i_{sc}). Given that in the example of FIG. 6 the “future” Point of Maximum Power (PMP) is to the right of the “old” one (M₀), the second point (m₂) is selected to the right of the first point (M₁) and can be written:

$${i}_{2} = m ( {i}_{SC} - {i}_{R} ( exp ( \frac{q}{nAkT} {v}_{2} ) - 1 )$$

which means that upon doing:

$${i}_{1} - {i}_{2} = {m i}_{R} ( exp ( \frac{q}{nAkT} {v}_{2} ) - ( exp ( \frac{q}{nAkT} {v}_{1} ) )$$

the short circuit current (i_{sc}) can be eliminated. And as the dark current (i_{R}) is known, one can write:

$$f ( \frac{q}{nAkT} ) = \frac{{i}_{1} - {i}_{2}}{{i}_{R}} - {m i}_{R} ( exp ( \frac{q}{nAkT} {v}_{2} ) - exp ( \frac{q}{nAkT} {v}_{1} ) ) = 0$$

This last equation can be solved by any numerical method of analysis applicable, for example applying the Newton-Raphson method leaves:

$${f}^{′} ( \frac{q}{nAkT} ) = - {v}_{2} ( exp ( \frac{q}{nAkT} {v}_{2} ) + {v}_{1} exp ( \frac{q}{nAkT} {v}_{1} ) )$$

and after j+1 iterations, the value of q/nAkT can be extracted by doing:

$$\frac{q}{nAkT} = \frac{q}{{nA}^{j} kT} - \frac{\frac{{i}_{1} - {i}_{2}}{{i}_{R}} - ( exp ( \frac{q}{{nA}^{j} kT} {v}_{2} ) + exp ( \frac{q}{{nA}^{j} kT} {v}_{1} ) )}{{v}_{2} ( exp ( \frac{q}{{nA}^{j} kT} {v}_{2} ) + {v}_{1} exp ( \frac{q}{{nA}^{j} kT} {v}_{1} ) )}$$

And after the value of the short circuit current (i_{sc}) can be obtained immediately by solving:

$${i}_{SC} = \frac{1}{m} ( {i}_{1} + {i}_{R} ( exp ( \frac{q}{nAkT} {v}_{1} ) - 1 ) \qquad ( 2.28 )$$

In the alternative case, wherein the variations in the lighting of the solar source (1) carry over to another point (M′₁) of operation where the current is less it is that at the “old” point (M₀), as previously mentioned, one can measure another second point (M′₂) which is to the left of the “old” point (M₀) in the electric characteristic. Nevertheless, the method for obtaining the values of the form factor of the characteristic (A) and the short circuit current (i_{sc}) does not change, it is the same as explained in the previous case.

The exactitude and velocity in the previous calculations depend on the appropriate choice of those second measurement points (M₂, M′₂). In practice, it is known, by the experience with the solar panels which are currently manufactured, that a change in the lighting conditions only slightly affects the parameter of the form factor of the characteristic (A). The same can be said about the temperature (T), since the high thermal inertia of the panel does not permit an abrupt thermal transition during the changing of lighting. Definitively, it can be considered that these factors (A, T) remain invariable during the changing of the lighting conditions of the solar source (1), at least as a valid approximation when defining the initial conditions in the search method of the Point of Maximum Power (PMP) which is being described. Furthermore, since computation time of the microprocessor to execute this method is of the order of a few hundredths of microseconds, the previous hypothesis can be accepted for that time interval.

Consequently, the second measurement point (M₂, M′₂) which is needed can be taken as the maximum power point established when the value of the short circuit current (i_{sc}) still has not been identified, thus approximating the value of voltage at said point (v₂), wherefore the following expression is given:

$${v}_{2} \approx {v}_{PMP} = \frac{nAkT}{q} Log ( 1 + \frac{{m i}_{SC} {i}_{PMP}}{{m i}_{R}} )$$

having calculated the short circuit current (i_{sc}) with the coordinates (v₁, i₁) of the first measurement point (M₁) according to the equation (2.28).

On the other hand, graphically, the derivative of the expression (2.14) corresponds to obtaining the gradient (p) of the straight line M1 M2, which is tangent to the curve at a third point (M₃) of coordinates (v₃, i₃) corresponding to the midpoint of the segment M₁ M₂, or:

$${v}_{3} = \frac{{v}_{1} + {v}_{2}}{2}$$

$${i}_{3} = \frac{{i}_{1} + {i}_{2}}{2}$$

and said gradient (p) is given by:

$$\frac{d v}{d i} = - na \frac{1}{{m i}_{SC} - i} = p \qquad ( 2.29 )$$

Eliminating the constant (a) between the equations (2.14) and (2.16) one arrives at the expression:

$$na = - p ( {m i}_{SC} - i ) = \frac{v}{Log ( \frac{{i}_{SC} - i}{{i}_{R}} )} \qquad ( 2.30 )$$

The extraction of the short circuit current (i_{sc}) of the electric characteristic is possible using the microprocessor to apply the Newton-Raphson iterative calculation method, with which after a number of iterations j+1 one can obtain:

$${i}_{SC}^{( j + 1 )} = {i}_{SC}^{( j )} - \frac{f ( {i}_{SC}^{( j )} )}{\frac{d f ( {i}_{SC}^{( j )} )}{d {i}_{SC}}} \qquad ( 2.31 )$$

being:

$$f ( {i}_{SC}^{( j )} ) = \frac{v}{np ( \frac{{mi}_{SC}^{( j )} - i}{{mi}_{R}} )} - Log ( \frac{{mi}_{SC}^{( j )} - i}{{mi}_{R}} ) \qquad ( 2.32 )$$

After determining the value in the working characteristic the short circuit current (i_{sc}), the microprocessor can find out the value of the constant (a) simply with the operation:

$$na = - p ( {m i}_{SC} - i ) = \frac{v}{Log ( \frac{{i}_{SC} - i}{{i}_{R}} )} \qquad ( 2.33 )$$

Equally, for the calculation at the Point of Maximum Power (PMP) of the current (iₚₘₚ), the microprocessor can apply the Newton-Raphson iterative algorithm, so:

$${i}_{PMP}^{( j + 1 )} = {i}^{( j )} - \frac{f ( {i}_{PMP}^{( j )} )}{\frac{d f ( {i}_{PMP}^{( j )} )}{d i}} \qquad ( 2.34 )$$

being:

$$f ( {i}_{PMP}^{( j )} ) = \frac{{i}_{PMP}^{( j )}}{{mi}_{R} ( 1 + \frac{{m i}_{SC} - {i}_{PMP}^{( j )}}{{mi}_{R}} )} - Log ( 1 + \frac{{m i}_{SC} - {i}_{PMP}^{( j )}}{{mi}_{R}} ) \qquad ( 2.35 )$$

Graphically, the calculation at the Point of Maximum Power (PMP) of the current (iₚₘₚ), is translated in obtaining the intersection point between the curves (f₁) and (f₂), which is single and corresponds to the value of current which makes becomes highest in the power function (P) and is the searched for Point of Maximum Power (PMP), in accordance with that illustrated in FIG. 1.

Following these steps which define this method for controlling the Point of Maximum Power (PMP), the calculation module (5) is capable of continuously predicting the coordinates (Vₚₘₚ, Iₚₘₚ), without disturbing the voltage supplied to the user loading network (4), which can be made of a bank of batteries, a motor or a DC pump, . . . . This method is valid even when the Point of Maximum Power (PMP) is modified by environmental changes of lighting, temperature, etc.
The power conditioning unit (2) regulates, following the reference signal supplied by the calculation module (5) and which establishes an interface with the solar source and said power conditioning unit (2). This independent calculation module (5) delivers in real time to the power cell (3) a value of voltage (Vₚₘₚ) in correspondence, i.e., rigorously proportional or equal to the instantaneous value of the voltage of the Point of Maximum Power (PMP) in terms of amplitude and length of time. The voltage thus regulated is the input voltage of a power cell (3) of type series or the voltage supplied to the user network (4) by a power structure of parallel type.

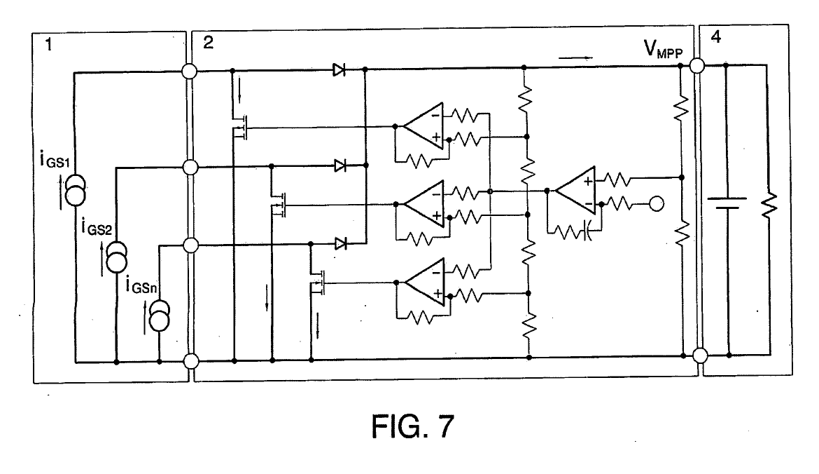

FIG. 7 represents the particular case wherein the power conditioning unit (2) has a structure of a sequential switching parallel regulator, for example of the known type S3R. The basic principle is to carry out an electronic switching which connected in parallel with a photovoltaic panel operates in two ways: in open circuit and in short circuit. The S3R regulator isolates the solar panels from the users during a part of the switching period and forces said solar panels, generators of currents (I_{GS1}, I_{GS2}, . . . , I_{GSn}) to work in a regulated voltage, such as that of the PMP obtained in this invention. The advantage that the use of the S3R regulator supposes is the minimization of the power dissipated in all the switches. Given that these switches only have two operational states, the solar panel will be good in short circuit and, therefore, the short circuit current (i_{sc}) is automatically known, or, supplying energy to the user loading network (4) through the diode connected in series. In this case the coordinates of the first working point (M1) are also automatically known. And, as a consequence, all the parameters are automatically available upon finding out the coordinates of said first working point (M1). The S3R regulator can also be applied to a structure in series, forcing the solar panels to operate at the reference voltage in open circuit.

In the event of using a S3R type unit with topology in parallel, as that shown in FIG. 7, the calculation of the PMP is immediate and it is not necessary to turn to a single measuring point, as the value of the short circuit current (i_{sc}) is always known and the value of the constant parameter (a) is calculated directly from the current (i1) measured continuously, from the working point (M1) of the solar panel, with the formula:

na=−p(mi_{sc}−i₁) (2.36)

The form factor of the characteristic (A) can also be obtained directly, since the coordinates of the working point (M1) are known, by means of the formula:

$${v}_{1} = \frac{nAkT}{q} Log ( 1 + \frac{{m i}_{SC} - {i}_{1}}{{mi}_{R}} ) \qquad ( 2.37 )$$

Alternatively, in the case of a power conditioning unit (2) with a series type power switching structure, such as the known ASR regulator, the piece of information directly available is the open circuit voltage (v_{oc}) and to find out the first working point (M1), it is known that when the switch in series is in conduction connecting the solar panel to the users, there exists a relationship that links the open circuit voltage (v_{oc}) with the short circuit current (i_{sc}) and the constant (a) of the electric characteristic, which is the following:

$${v}_{OC} = \frac{nAkT}{q} Log \frac{{i}_{SC}}{{i}_{R}} = na Log \frac{{i}_{SC}}{{i}_{R}} \qquad ( 2.38 )$$

Then, the microprocessor can easily calculate the solution of the two equation system (2.37) and (2.38) in order to obtain the first point (M1) of the characteristic of the solar source (1). The calculation of the rest of the parameters of the electric characteristic do not depend on the voltage and current measurements of the second point (M2) to generate the straight line M1′M2 or M1″M2″ seen in FIG. 6. And to update the value of the dark current (i_{R}) it is enough with the measurement in each updating period of two points (M1, M2) of coordinates (v1, i1) and (v2, i2) respectively, being able to write it:

$${i}_{1} = m ( {i}_{SC} - {i}_{R} ( exp ( \frac{q}{nAkT} {v}_{1} ) - 1 ) \\ {i}_{2} = m ( {i}_{SC} - {i}_{R} ( exp ( \frac{q}{nAkT} {v}_{2} ) - 1 )$$

and extract the value of the dark current (i_{R}) of the two previous equations, making:

$$\frac{{i}_{SC} - {i}_{1}}{{i}_{SC} - {i}_{2}} ≅ exp ( \frac{q}{nAkT} ( {v}_{1} - {v}_{2} ) )$$

$$which takes you to \text{:} \frac{q}{nAkT} = \frac{1}{( {v}_{1} - {v}_{2} )} Ln \frac{{i}_{SC} - {i}_{1}}{{i}_{SC} - {i}_{2}}$$

$$resulting in \text{:} {i}_{R} = \frac{{i}_{SC} - {i}_{1}}{exp ( \frac{q}{nAkT} {v}_{1} )}$$

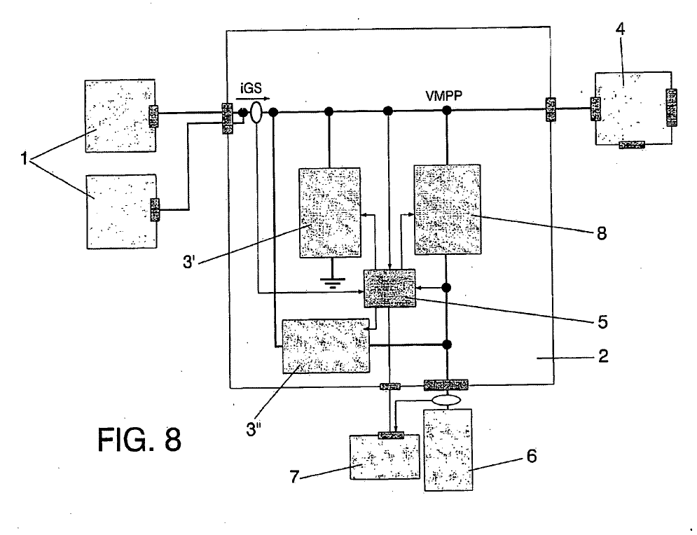

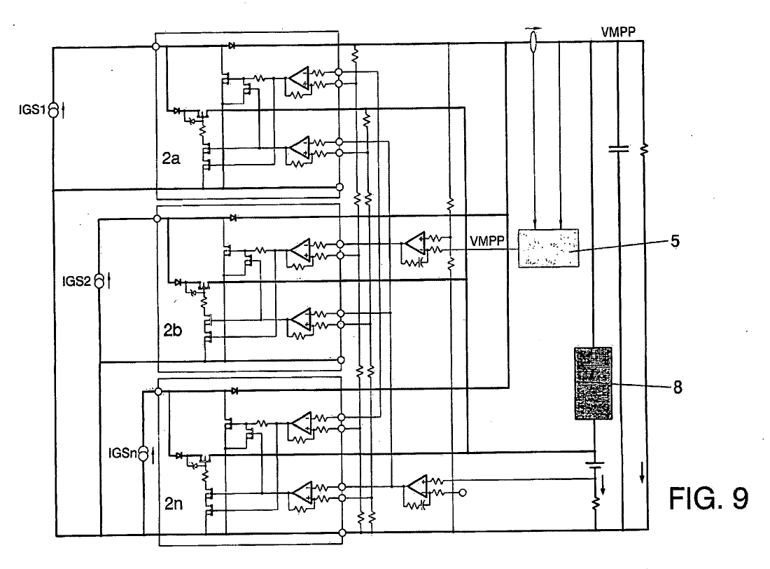

Another possible topology that can be used to implement the power conditioning unit (2) is that known as type S4R, represented as a block diagram in FIG. 8, with the connection to a battery (6), a battery control (7) and a battery porter (8). This power conditioning unit (2) type S4R includes a series power cell (3′) and a parallel power cell (3″). Several of these S4R units (2a, 2b, . . . , 2n) can be connected following the diagram of FIG. 9, controlled by a single calculation module (5). Connected to the respective solar panels that compose the solar source (1) are the series and parallel power cells of each S4R unit (2a, 2b, . . . , 2n), and between the battery (6) and the loading network (4) is connected in series the battery porter (8) which functions in sample mode and isolates that battery (6) from the solar panels and from the network.

The terms in which this specification has been written shall always be taken broadly and non-limitatively.

Some preferred embodiments of the invention are disclosed in the dependent claims which are included below.

1. Method for controlling the Point of Maximum Power for solar energy sources, whose electric voltage characteristic (v) depending on the current (i) has a single Point of Maximum Power (PMP) corresponding to the maximum of the power function P=vi, the source being connected to a user loading network (4) by means of a power conditioning unit (2) and comprising at least one photovoltaic panel constituted by a plurality of cells distributed in a number of rows (n) and a number of columns (m), characterized in that
it establishes a reference voltage (Vₚₘₚ) in correspondence to the value in real time of the voltage at the Point of Maximum Power (PMP), from less than four measurement points (M1, M2, M3) of the electric characteristic, the reference voltage (Vₚₘₚ) being used by the power conditioning unit (2) to regulate the output voltage of the solar source (1) without interrupting the voltage supply to the user loading network (4).

2. Method according to claim 1, characterized in that it additionally calculates the value of the current (Iₚₘₚ) at the Point of Maximum Power (PMP) solving the differential equation
dP=Vₚₘₚdi+Iₚₘₚdv=0

3. Method according to claim 2, characterized in that the reference voltage (Vₚₘₚ) is calculated from the value of the current (Iₚₘₚ) at the Point of Maximum Power (PMP) following the formula
$${v}_{PMP} = na Log ( 1 + \frac{{m i}_{SC} - {i}_{PMP}}{{mi}_{R}} )$$
from particularizing the electric characteristic at the Point of Maximum Power (PMP), function of a constant (a) dependent on the material and temperature of the photovoltaic cells, the short circuit current (6) and the dark current (i_{R}) of said panel cells.

4. Method according to claim 3, characterized in that, being the voltage and current coordinates from the points of the characteristic (M1, M2, M3) respectively (v1, i1), (v2, i2) and (v3, i3), it uses a single point (M2) to calculate:
$${v}_{3} = \frac{{v}_{1} + {v}_{2}}{2} y {i}_{3} = \frac{{i}_{1} + {i}_{2}}{2}$$
the gradient (p) of the tangent to the characteristic:
$$\frac{d v}{d i} = - \frac{n}{m} \frac{AkT}{{qi}_{R}} \frac{1}{1 + \frac{{mi}_{SC} - {i}_{3}}{{mi}_{R}}} = - na \frac{1}{{mi}_{SC} - {i}_{3}} = p$$
$$and$$
$$na = - p ( {mi}_{SC} - {i}_{3} ) = \frac{{v}_{3}}{Log ( \frac{{i}_{SC} - {i}_{3}}{{i}_{R}} )}$$

5. Method according to claim 4, characterized in that the instantaneous value of the short circuit current (i_{sc}) and the constant (a) are calculated by means of a iterative calculation method and a graphic method, from a specific initial value of the dark current (i_{R}).

6. Method according to claim 5, characterized in that the iterative calculation method is that of Newton-Raphson.

7. Method according to claim 5, characterized in that the graphic method consists of determining the intersection between two curves function of the current (i) of the solar source, which are first curve (f₁).
$${f}_{1} = \frac{v}{i} = \frac{n AkT}{qi} Log ( 1 + \frac{{mi}_{SC} - i}{{mi}_{R}} )$$
and second curve (f₂),
$${f}_{2} = \vert \frac{d v}{d i} \vert = \frac{n}{m} \frac{AkT}{{qi}_{R}} \frac{1}{1 + \frac{{mi}_{SC} - i}{{mi}_{R}}}$$

8. Method according to claim 5, characterized in that the initial value of the dark current (i_{R}) is determined from known data of the solar source and which are
voltage and current at the Point of Maximum Power (PMP) for normal conditions of pressure and temperature,
open circuit voltage for the normal conditions of pressure and temperature, and
short circuit voltage for the normal conditions of pressure and temperature.

9. Method according to claim 5, characterized in that the initial value of the dark current (i_{R}) is periodically updated from the values calculated from the short circuit current (i_{sc}) and the constant (a).

10. Method according to claim 1, characterized in that the calculation of the reference voltage (Vₚₘₚ) comprises the following steps:
first step: identifying an analytic form depending on the time (t) of the electric characteristic of the solar source (1), in accordance with the equations:
$$i ( t ) = m ( {i}_{SC} ( t ) - {i}_{R} ( exp ( \frac{qv ( t )}{nAkT} ) - 1 ) )$$
$$P ( t ) = v ( t ) i ( t )$$
with form factor values of the characteristic (A), short circuit current (6) and dark current (i_{R}) calculated.
second step: solving the differential equation:
$$\frac{d P}{d v} = \frac{nAkT}{q} ( Log ( \frac{{mi}_{SC} - {i}_{PMP}}{{mi}_{R}} ) - \frac{{i}_{PMP}}{{mi}_{R} ( 1 + \frac{{i}_{SC} - {i}_{PMP}}{{mi}_{R}} )} ) = 0$$
third step: generating an analogue reference signal proportional to the voltage value that is calculated according to the expression:
$${v}_{PMP} = \frac{nAkT}{q} Log ( 1 + \frac{{mi}_{SC} - {i}_{PMP}}{{mi}_{R}} )$$

11. Method according to claim 10, characterized in that the form factor values of the characteristic (A), short circuit current (i_{sc}) and dark current (i_{R}) are calculated from three measurement points (M1, M2, M3) of the electric characteristic.

12. Method according to claim 10, characterized in that the form factor values of the characteristic (A) and the short circuit current (i_{sc}) are calculated from two measurement points (M1, M2) of the electric characteristic, and in that the dark current value (i_{R}) is initially equal to the value given by the manufacturer of the solar source (1) and in that the value of the dark current (iR9 is periodically updated from the measurements obtained.

13. Method according to claim 12, characterized in that the value of the dark current (i_{R}) is periodically updated solving a three system equation whose unknown quantities are the form factor of the characteristic (A), the short circuit current (i_{sc}) and the dark current (i_{R}), which are given by:
$${i}_{1} = m ( {i}_{SC} - {i}_{R} ( exp ( \frac{q}{nAkT} {v}_{1} ) - 1 ) \\ {i}_{2} = m ( {i}_{SC} - {i}_{R} ( exp ( \frac{q}{nAkT} {v}_{2} ) - 1 ) \\ {i}_{3} = m ( {i}_{SC} - {i}_{R} ( exp ( \frac{q}{nAkT} {v}_{3} ) - 1 )$$
where the two measurement points (M1, M2) of the electric characteristic are defined by electric current and voltage coordinates (v1, i1) and (v2, i2) respectively; together with electric current and voltage coordinates (v3, i3) corresponding to a working point (M3) chosen from said two measurement points (M1, M2) of the electric characteristic.

14. Method according to claim 13, characterized in that the value of the dark current (iR9 is periodically updated according to the following expression:
$${i}_{R} = \frac{{i}_{1} - {i}_{2}}{exp ( \frac{q}{nAkT} {v}_{2} ) - exp ( \frac{q}{nAkT} {v}_{1} )}$$
from the two measurement points (M1, M2) of the electric characteristic defined by electric current and voltage coordinates (v1, i1) and (v2, i2) respectively.

15. Circuit for controlling the Point of Maximum Power for solar energy sources, being a solar source (1) which comprises at least one photovoltaic panel constituted by a plurality of cells distributed in a number of rows (n) and a number of columns (m), the solar source (1) equipped with an electric voltage characteristic (v) depending on the current (i) which has a single Point of Maximum Power (PMP) corresponding to the maximum of the power function P=vi, and said circuit comprising
a power conditioning unit (2) connected between the solar source (1) and a user loading network (4), through a power cell (3), in order to regulate the output voltage of the solar source (1) and supply voltage to the user loading network (4),
a calculation module (5) of the Point of Maximum Power (PMP) connected to the power cell (3),
Characterized in that the calculation module (5) comprises
at least one programmable electronic device configure to establish, without interrupting the voltage supply to the user loading network (4), a reference voltage (Vₚₘₚ) in correspondence to the value in real time of the voltage at the Point of Maximum Power (PMP);
means of storage associated with the programmable electronic device capable of saving the data necessary in the establishment of the reference voltage (Vₚₘₚ);
an interface with the solar source (1) constituted by digital analogue converters to receive the measurement points (M1, M2, M3) of the electric characteristic and digital analogue converters to deliver the reference voltage (Vₚₘₚ) to the power cell (3).

16. Circuit according to claim 15, characterized in that the power conditioning unit (2) has the power cell (3) connected in series.

17. Circuit according to claim 15, characterized in that the power conditioning unit (2) has the power cell (3) connected in parallel.

18. Circuit according to claim 15, characterized in that the power cell (3) has an S3R topology.

19. Circuit according to claim 18, characterized in that the programmable electronic device is configured to establish the reference voltage (Vₚₘₚ) solving:
$${v}_{PMP} = \frac{nAkT}{q} Log ( 1 + \frac{{mi}_{SC} - {i}_{PMP}}{{mi}_{R}} )$$
with initial form factor values of the characteristic (A) and dark current (i_{R}), together with a short circuit current value (i_{sc}) obtained directly and which corresponds to:
if the power cell (3) is connected in parallel, to a value of current measured when the power cell (3) puts the solar source (1) in short circuit;
if the power cell (3) is connected in series, to a value calculated according to the expression:
and a value of open circuit voltage (v_{oc}) measured when the power cell (3) puts the solar source (1) in open circuit.

20. Circuit according to claim 15, characterized in that the programmable electronic device is configured to establish the reference voltage (Vₚₘₚ) from a single measurement point (M2), using a previous working point (M1) and internally obtaining a third point of the characteristic (M3) from the two working and measurement points (M1, M2).

21. Circuit according to claim 20, characterized in that the programmable electronic device is configured to internally obtain the third point of the characteristic (M3) determining a midpoint between the two working and measurement points (M1, M2).

22. Circuit according to claim 15, characterized in that the programmable electronic device is integrated in the power conditioning unit (2).

23. Circuit according to claim 15, characterized in that the means of storage consists of an memory integrated in the programmable electronic device.

24. Circuit according to claim 15, characterized in that the programmable electronic device is selected from a general purpose microprocessor, a digital signal microprocessor (DSP), an application specific integrated circuit (ASCI) and a programmable card (FPGA) or any other combination of these.

25. Circuit according to claim 15, characterized in that the programmable electronic device is configured to calculate the value of the current (Iₚₘₚ) at the Point of Maximum Power (PMP) solving the differential equation
dP=Vₚₘₚdi+Iₚₘₚdv (2.49)

26. Circuit according to claim 25, characterized in that the programmable electronic device is configured to use the value of the current (Iₚₘₚ) at the Point of Maximum Power (PMP) in the establishment of the reference voltage (Vₚₘₚ) calculating it by following the formula
$${v}_{PMP} = na Log ( 1 + \frac{{mi}_{SC} - {i}_{PMP}}{{mi}_{R}} ) \qquad ( 2.50 )$$
from particularizing the electric characteristic at the Point of Maximum Power (PMP), function of a constant (a) dependent on the material and temperature of the photovoltaic cells, the short circuit current (i_{sc}) and the dark current (i_{R}) of said panel cells.

27. Circuit according to claim 26, characterized in that, the voltage and current coordinates of the points (M1, M2, M3) being respectively (v1,i1), (v2,i2) and (v3,i3), the programmable electronic device is configured to calculate the value of two parameters which are
first parameter (mi_{sc}),
second parameter (na)
Knowing the dark current (i_{R}) with the data of the manufacturer at the beginning and periodically updating it with the stored data.

28. Circuit according to claim 27, characterized in that the programmable electronic device is configured to calculate the value of the first two parameters (mi_{sc}, na) by means of an iterative method and a graphic method, from a determined initial value of the dark current (i_{R}).

29. Circuit according to claim 28, characterized in that the programmable electronic device is configured to execute the Newton-Raphson iterative calculation method.

30. Circuit according to claim 28, characterized in that the programmable electronic device is configured to execute the graphic calculation method which consist of determining the intersection between two curves function of the current (i) of the solar source, which are
$$\begin{matrix}first curve ( f 1 ) , & \\ {f}_{1} = \frac{v}{i} = \frac{nAkT}{qi} Log ( 1 + \frac{{mi}_{SC} - i}{{mi}_{R}} ) \\ and & ( 2.51 ) \\ second curve ( f 2 ) , & \\ {f}_{2} = \vert \frac{d v}{d i} \vert = \frac{n}{m} \frac{AkT}{{qi}_{R}} \frac{1}{1 + \frac{{mi}_{SC} - i}{{mi}_{R}}} . & ( 2.52 )\end{matrix}$$

31. Circuit according to claim 28, characterized in that the programmable electronic device is configured to determine the initial value of the dark current (i_{R}) from data known from the solar source saved in the means of storage and which are
voltage and current at the Point of Maximum Power (PMP) for normal conditions of pressure and temperature,
open circuit voltage for the normal conditions of pressure and temperature, and
short circuit voltage for the normal conditions of pressure and temperature.

32. Circuit according to claim 28, characterized in that the programmable electronic device is configured to periodically update the initial value of the dark current (i_{R}) from the values calculated form the two parameters (mi_{sc}, na).

33. Circuit according to claim 28, characterized in that it comprises a current pick-up adapted to measure the value of the current (i) in real time and in that the programmable electronic device is configured to perform the method for controlling the Point of Maximum Power (PMP), when the difference between said value of the current (i) in real time and the value of the current (Iₚₘₚ) at the Point of Maximum Power (PMP) surpass a pre-determined limit.

34. Solar generator characterized in that it incorporates a circuit for controlling the Point of Maximum Power for solar energy sources, being a solar source (1) which comprises at least one photovoltaic panel constituted by a plurality of cells distributed in a number of rows (n) and a number of columns (m), the solar source (1) equipped with an electric voltage characteristic (v) depending on the current (i) which has a single Point of Maximum Power (PMP) corresponding to the maximum of the power function P=vi, and said circuit comprising
a power conditioning unit (2) connected between the solar source (1) and a user loading network (4), through a power cell (3), in order to regulate the output voltage of the solar source (1) and supply voltage to the user loading network (4),
a calculation module (5) of the Point of Maximum Power (PMP) connected to the power cell (3),
Characterized in that the calculation module (5) comprises
at least one programmable electronic device configure to establish, without interrupting the voltage supply to the user loading network (4), a reference voltage (Vₚₘₚ) in correspondence to the value in real time of the voltage at the Point of Maximum Power (PMP);
means of storage associated with the programmable electronic device capable of saving the data necessary in the establishment of the reference voltage (Vₚₘₚ);
an interface with the solar source (1) constituted by digital analogue converters to receive the measurement points (M1, M2, M3) of the electric characteristic and digital analogue converters to deliver the reference voltage (Vₚₘₚ) to the power cell (3).

35. Solar generator according to claim 34, characterized in that the power conditioning unit (2) has the power cell (3) connected in series.

36. Solar generator according to claim 34, characterized in that the power conditioning unit (2) has the power cell (3) connected in parallel.

37. Solar generator according to claim 34, characterized in that the power cell (3) has an S3R topology.

38. Solar generator according to claim 37, characterized in that the programmable electronic device is configured to establish the reference voltage (Vₚₘₚ) solving:
$${v}_{PMP} = \frac{nAkT}{q} Log ( 1 + \frac{{mi}_{SC} - {i}_{PMP}}{{mi}_{R}} )$$
with initial form factor values of the characteristic (A) and dark current (i_{R}), together with a short circuit current value (i_{sc}) obtained directly and which corresponds to:
if the power cell (3) is connected in parallel, to a value of current measured when the power cell (3) puts the solar source (1) in short circuit;
if the power cell (3) is connected in series, to a value calculated according to the expression:
and a value of open circuit voltage (v_{oc}) measured when the power cell (3) puts the solar source (1) in open circuit.

39. Solar generator according to claim 34, characterized in that the programmable electronic device is configured to establish the reference voltage (Vₚₘₚ) from a single measurement point (M2), using a previous working point (M1) and internally obtaining a third point of the characteristic (M3) from the two working and measurement points (M1, M2).

40. Solar generator according to claim 39, characterized in that the programmable electronic device is configured to internally obtain the third point of the characteristic (M3) determining a midpoint between the two working and measurement points (M1, M2).

41. Solar generator according to claim 34, characterized in that the programmable electronic device is integrated in the power conditioning unit (2).

42. Solar generator according to claim 34, characterized in that the means of storage consists of an memory integrated in the programmable electronic device.

43. Solar generator according to claim 34, characterized in that the programmable electronic device is selected from a general purpose microprocessor, a digital signal microprocessor (DSP), an application specific integrated circuit (ASCI) and a programmable card (FPGA) or any other combination of these.

44. Solar generator according to claim 34, characterized in that the programmable electronic device is configured to calculate the value of the current (Iₚₘₚ) at the Point of Maximum Power (PMP) solving the differential equation
dP=Vₚₘₚdi+Iₚₘₚdv (2.49)

45. Solar generator according to claim 44, characterized in that the programmable electronic device is configured to use the value of the current (Iₚₘₚ) at the Point of Maximum Power (PMP) in the establishment of the reference voltage (Vₚₘₚ) calculating it by following the formula
$${v}_{PMP} = na Log ( 1 + \frac{{mi}_{SC} - {i}_{PMP}}{{mi}_{R}} ) \qquad ( 2.50 )$$
from particularizing the electric characteristic at the Point of Maximum Power (PMP), function of a constant (a) dependent on the material and temperature of the photovoltaic cells, the short circuit current (i_{sc}) and the dark current (i_{R}) of said panel cells.

46. Solar generator according to claim 45, characterized in that, the voltage and current coordinates of the points (M1, M2, M3) being respectively (v1,i1), (v2,i2) and (v3,i3), the programmable electronic device is configured to calculate the value of two parameters which are
first parameter (mi_{sc}),
second parameter (na)
Knowing the dark current (i_{R}) with the data of the manufacturer at the beginning and periodically updating it with the stored data.

47. Solar generator according to claim 46, characterized in that the programmable electronic device is configured to calculate the value of the first two parameters (mi_{sc}, na) by means of an iterative method and a graphic method, from a determined initial value of the dark current (i_{R}).

48. Solar generator according to claim 47, characterized in that the programmable electronic device is configured to execute the Newton-Raphson iterative calculation method.

49. Solar generator according to claim 47, characterized in that the programmable electronic device is configured to execute the graphic calculation method which consist of determining the intersection between two curves function of the current (i) of the solar source, which are
$$\begin{matrix}first curve ( f 1 ) , & \\ {f}_{1} = \frac{v}{i} = \frac{nAkT}{qi} Log ( 1 + \frac{{mi}_{SC} - i}{{mi}_{R}} ) \\ and & ( 2.51 ) \\ second curve ( f 2 ) , & \\ {f}_{2} = \vert \frac{d v}{d i} \vert = \frac{n}{m} \frac{AkT}{{qi}_{R}} \frac{1}{1 + \frac{{mi}_{SC} - i}{{mi}_{R}}} . & ( 2.52 )\end{matrix}$$

50. Solar generator according to claim 47, characterized in that the programmable electronic device is configured to determine the initial value of the dark current (i_{R}) from data known from the solar source saved in the means of storage and which are
voltage and current at the Point of Maximum Power (PMP) for normal conditions of pressure and temperature,
open circuit voltage for the normal conditions of pressure and temperature, and
short circuit voltage for the normal conditions of pressure and temperature.

51. Solar generator according to claim 47, characterized in that the programmable, electronic device is configured to periodically update the initial value of the dark current (i_{R}) from the values calculated form the two parameters (mi_{sc}, na).

52. Solar generator according to claim 47, characterized in that it comprises a current pick-up adapted to measure the value of the current (i) in real time and in that the programmable electronic device is configured to perform the method for controlling the Point of Maximum Power (PMP), when the difference between said value of the current (i) in real time and the value of the current (Iₚₘₚ) at the Point of Maximum Power (PMP) surpass a pre-determined limit.
